(19) United States
(12) Patent Application Publication
(10) Pub. No.: US 2024/0064715 A1
(43) Pub. Date: Feb. 22, 2024

(54) RESOURCE COORDINATION SCHEMES IN WIRELESS COMMUNICATIONS

(71) Applicant: ZTE Corporation, Shenzhen (CN)

(72) Inventors: Ying HUANG, Shenzhen (CN); Lin CHEN, Shenzhen (CN)

(21) Appl. No.: 18/386,234

(22) Filed: Nov. 1, 2023

Related U.S. Application Data
(63) Continuation of application No. PCT/CN2021/091823, filed on May 6, 2021.

(51) Int. Cl. H04W 72/0446

(52) U.S. Cl. CPC H04W 72/0446

(57) ABSTRACT

A method of wireless communication is described. The method of wireless communication comprises receiving, by a first node of an integrated access and backhaul (IAB) network, resource information that includes resource availability information and/or resource configuration information; and transmitting, by the first node, the resource information to a second node.

### CROSS-REFERENCE TO RELATED APPLICATIONS

This application is a continuation of International Patent Application No. PCT/CN2021/091823, filed on May 6, 2021, the contents of which are incorporated herein by reference in their entirety.

### TECHNICAL FIELD

This patent document generally relates to systems, devices, and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices.

### SUMMARY

This document relates to methods, systems, and devices for resource distribution schemes in wireless communications.

In one aspect, a wireless communication method is disclosed. The method includes receiving, by a first node of an integrated access and backhaul (IAB) network, resource information that includes resource availability information and/or resource configuration information; and transmitting, by the first node, the resource information to a second node.

In another aspect, a wireless communication method is disclosed. The method includes receiving, by a first node of an integrated access and backhaul (IAB) network, a resource configuration information from a second node, wherein the first node is a first donor node, the second node is a second donor node or an IAB node.

In another aspect, a wireless communication method is disclosed. The method includes transmitting, by a first node of an integrated access and backhaul (IAB) network, resource information to a second node, wherein the resource information includes resource availability information indicative of a resource availability and/or resource configuration information.

These, and other features, are described in the present document.

### BRIEF DESCRIPTION OF THE DRAWING

FIGS. 1A and 1B illustrate a general architecture of an integrated access and backhaul (IAB) network.

FIG. 2 shows a diagram illustrating a relationship between a parent node and a child node for IAB nodes.

FIG. 3A illustrates an intra-donor CU topology and FIG. 3B illustrates an inter-donor CU topology.

FIG. 4 shows an example of wireless communication including a base station (BS) and user equipment (UE) based on some implementations of the disclosed technology.

FIG. 5 shows an example of a block diagram of a portion of an apparatus based on some implementations of the disclosed technology.

FIGS. 6-8 illustrate flowcharts showing example methods of wireless communication based on some implementations of the disclosed technology.

### DETAILED DESCRIPTION

The disclosed technology provides implementations and examples of resource coordination schemes in wireless communications.

Integrated access and backhaul (IAB) supports wireless backhauling via new radio (NR) enabling flexible and very dense deployment of NR cells while reducing the need for wireline transport infrastructure. Intra-donor CU (centralized unit) topology adaptation, intra-donor CU backhaul radio link failure (BH RLF) recovery and intra-donor CU topology redundancy have been studied and specified in the relevant specification (e.g., R16 IAB) in which both two parent node are served by the same IAB-donor-CU. Some implementations of the disclosed technology provide solutions for inter-donor CU topology adaptation, inter-donor CU BH RLF recovery and/or inter-donor CU topology redundancy.

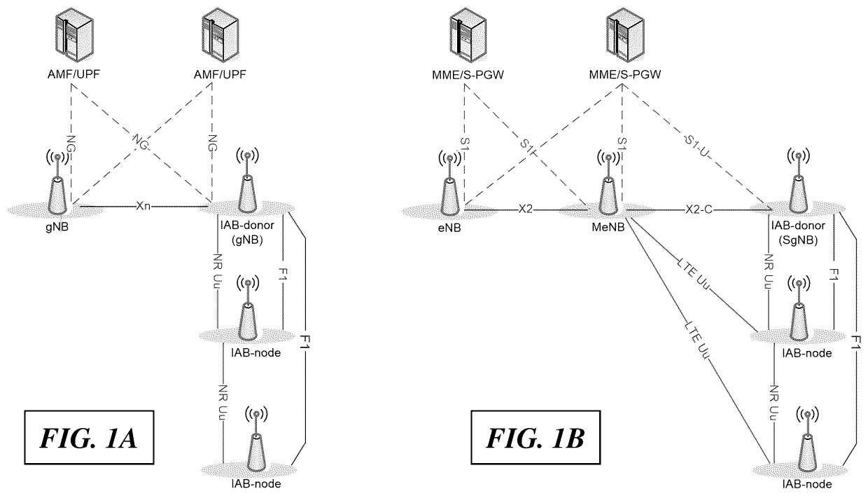

Integrated access and backhaul (IAB) enables wireless relaying in NG-RAN. The relaying node, referred to as IAB-node, supports access and backhauling via NR. The terminating node of NR backhauling on network side is referred to as the IAB-donor, which represents a gNB with additional functionality to support IAB. Backhauling can occur via a single or via multiple hops. The general IAB architecture is shown in FIG. 1A and FIG. 1B.

The IAB-node supports gNB-DU functionality to terminate the NR access interface to UEs and next-hop IAB-nodes, and to terminate the F1 protocol to the gNB-CU functionality on the IAB-donor. The gNB-DU functionality on the IAB-node is also referred to as IAB-DU.

In addition to the gNB-DU functionality, the IAB-node also supports a subset of the UE functionality referred to as IAB-MT, which includes, e.g., physical layer, layer-2, RRC and NAS functionality to connect to the gNB-DU of another IAB-node or the IAB-donor, to connect to the gNB-CU on the IAB-donor, and to the core network. The IAB-node can access the network using either SA-mode or EN-DC. In EN-DC, the IAB-node also connects via E-UTRA to a MeNB, and the IAB-donor terminates X2-C as SgNB.

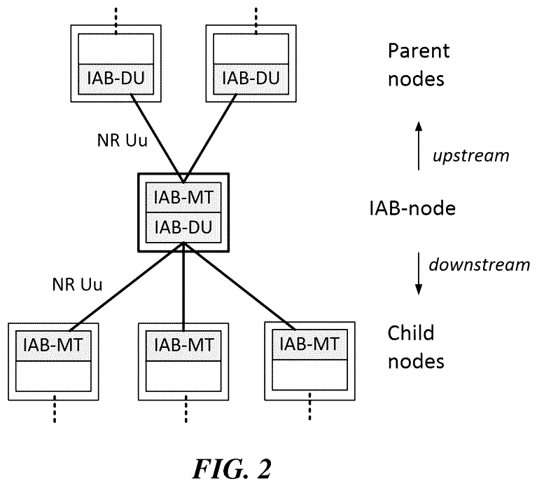

FIG. 2 shows a diagram illustrating a relationship between a parent node and a child node for IAB nodes. Referring to FIG. 2, all IAB-nodes that are connected to an IAB-donor via one or multiple hops form a directed acyclic graph (DAG) topology with the IAB-donor at its root. In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream. The IAB-donor performs centralized resource, topology and route management for the IAB topology.

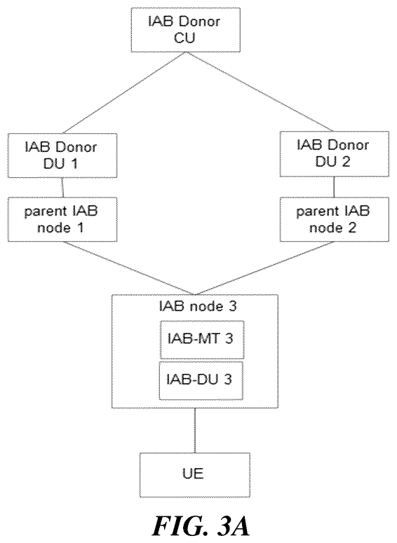

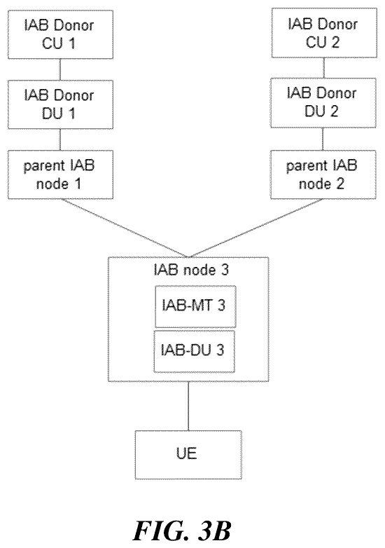

The following scenarios are examples of scenarios to which some implementations of the disclosed technology are applied. FIG. 3A illustrates an intra-donor CU topology and FIG. 3B illustrates an inter-donor CU topology.

Scenario 1

In inter-donor CU migration scenario, the parent IAB node, donor DU and donor CU of the migrating IAB node are changed after migration. Referring to FIG. 3A, the IAB node 3 migrates from the parent IAB node 1 to the parent IAB node 2. The parent IAB node 1 is the source parent IAB node while the parent IAB node 2 is the target parent IAB node. The donor DU 1 is the source donor DU while the donor DU 2 is the target donor DU. The Donor CU 1 is the source donor CU while the donor CU 2 is the target donor CU.

Scenario 2

In inter-donor CU BH RLF recovery scenario, the IAB-node changes from its initial parent node to a new parent node, where the new parent node is served by an IAB-donor-DU different than the one serving its initial parent node. Referring to FIG. 3A, the IAB node 3 declares a backhaul RLF for the link between the parent IAB node 1 and the IAB node 3. Then, the IAB node 3 recovers with the parent IAB node 2. The parent IAB node 1 is the initial parent IAB node while the parent IAB node 2 is the new parent IAB node. The donor DU 1 is the initial donor DU while the donor DU 2 is the new donor DU. The donor CU 1 is the initial donor CU while the donor CU 2 is the new donor CU.

Scenario 3

In intra-donor CU topology redundancy scenario, one IAB-node, referred to as the dual-connecting IAB-node, has two paths towards the IAB-donor CU via different IAB-donor-DUs.

Scenario 4

In inter-donor CU topology redundancy scenario, one IAB-node, referred to as the dual-connecting IAB-node, has two paths towards two different IAB-donor CUs via different IAB-donor-DUs. As illustrated in FIG. 3A, the IAB node 3 connects to both of the parent IAB node 1 and the parent IAB node 2 which are connected to two different donor CUs. The parent IAB node 1 is the first parent IAB node while the parent IAB node 2 is the second parent IAB node. The donor DU 1 is the first path donor DU while the donor DU 2 is the second path donor DU. The donor CU 1 is the first path donor CU while the donor CU 2 is the second path donor CU.

Implementation 1—Scheduling Collision Between Two Parent DUs

TDM (time domain multiplex) is used between a parent link and a child link of an IAB node to meet the half-duplexing constraint of an IAB node that is specified in the relevant specification. For example, some specification requires that the IAB node reports multiplexing capabilities between the gNB-DU's cell and the cells configured on the collocated IAB-MT to donor CU. The donor CU could send IAB node's multiplexing capabilities to its parent node. Then the donor CU configures semi-static time-domain resource and corresponding H/S/NA (Hard/Soft/NotAvailable) attribute for IAB-DU cells based on multiplexing capabilities of the IAB node. The parent IAB node could dynamically send soft resource availability indication information via DCI format 2-5 to the IAB node. The soft resource availability indication information is used to indicate the resource availability of soft symbols for a set of consecutive slots in the time domain. In this way, the IAB-DU could determine available time domain resources for serving UE/child IAB-MT.

In intra-donor CU or inter-donor CU topology redundancy scenario, there would be scheduling collision between two parent IAB-DUs due to soft resource availability indication received by an IAB node from both parent IAB nodes.

Solution 1 (Intra-Donor CU Scenario)

The second parent IAB node needs to be aware of the soft resource availability related information configured by the IAB node, which is received from the first parent IAB node. The following steps are performed to send the soft resource availability related information to the second parent IAB node.

Step 1: An IAB node (e.g., IAB node 3 in FIG. 3A) receives soft resource availability related information from the first parent IAB node.

Step 2: The IAB node sends soft resource availability related information to the IAB donor CU via RRC message or F1AP message.

Step 3: The IAB donor CU sends soft resource availability related information to the second parent IAB node via RRC message or F1AP message.

Solution 2 (Intra-Donor CU Scenario)

The second parent IAB node needs to be aware of the soft resource availability related information configured by the IAB node. The following steps are performed to send the soft resource availability related information to the second parent IAB node.

Step 1: The first parent IAB node of an IAB node (e.g., IAB node 3 in FIG. 3A) sends soft resource availability related information to the IAB donor CU via RRC message or F1AP message.

Step 2: The IAB donor CU sends soft resource availability related information to the second parent IAB node of the IAB node via RRC message or F1AP message.

Solution 3 (Inter-Donor CU Scenario)

The second parent IAB node needs to be aware of the soft resource availability related information configured by the IAB node, which is received from the first parent IAB node. The following steps are performed to send the soft resource availability related information to the second parent IAB node.

Step 1: An IAB node (e.g., IAB node in FIG. 3B) receives soft resource availability related information from the first parent IAB node.

Step 2: The IAB node sends soft resource availability related information to the first IAB donor CU via RRC message or F1AP message.

Step 3: The first IAB donor CU sends soft resource availability related information to the second IAB donor CU.

Step 4: The second IAB donor CU sends soft resource availability related information to the second parent IAB node via RRC message or FLAP message.

Solution 4 (Inter-Donor CU Scenario)

The second parent IAB node needs to be aware of the soft resource availability related information configured by the IAB node. The following steps are performed to send the soft resource availability related information to the second parent IAB node.

Step 1: The first parent IAB node of an IAB node (e.g., IAB node in FIG. 3B) sends soft resource availability related information to the first IAB donor CU via RRC message or F1AP message.

Step 2: The first IAB donor CU sends soft resource availability related information to the second IAB donor CU.

Step 3: The second IAB donor CU sends soft resource availability related information to the second parent IAB node via RRC message or FLAP message.

In the above implementations, soft resource availability related information comprises at least one of the following: Soft resource availability indication information, Identity of IAB-DU (e.g., backhaul adaptation protocol (BAP) address), identity of IAB-DU cell (e.g., cell identity), identity of collocated IAB-MT, subcarrier spacing, DUF (downlink/uplink/flexible) transmission periodicity, DUF slot configuration list, HSNA (hard/soft/not-available) transmission periodicity, HSNA slot configuration list, mutiplex information, cell specific signal/channel configuration (e.g. IAB STC Info, RACH, CSI-RS/SR configuration, PDCCH configuration SIB1, SCS Common)

Implementation 2—Resource Coordination to Meet Half Duplex Constraint

In inter-donor CU migration or inter-donor CU topology redundancy scenario, how to perform resource coordination between IAB donor CUs to meet the half duplex constraint in IAB node. For example, the radio resource and cell specific channel/signal configuration used in the parent link and the child link may be configured by different IAB donor CUs. In this situation, there might be an interference between the child link and the parent link. The solutions below are provided to address this issue.

Solutions for Migration Scenario

The following solutions are discussed to make the source IAB donor aware of the resource configuration of the target parent IAB node:

Solution 1: A target IAB donor CU sends target parent IAB-DU's resource configuration to a source IAB donor CU via XnAP message. The source IAB donor CU can allocate resource used by a migrating IAB node (e.g., IAB node 3 in FIG. 3A or 3B) based on the received resource configuration.

Solution 2: A migrating IAB node (e.g., IAB node 3 in FIG. 3A or 3B) sends target parent IAB-DU's resource configuration to the source IAB donor CU via RRC or F1AP message. The source IAB donor CU configures resources based on the received resource configuration.

Solutions for Redundancy Scenario

The following solutions are discussed to make the first IAB donor or the second IAB donor aware of the resource configuration of the boundary IAB or the second parent IAB.

Solution 1: A first IAB-donor CU sends boundary IAB-DU's and first parent IAB-DU's resource configuration to the second IAB-donor CU via XnAP message.

Solution 2: A second IAB-donor CU sends second parent IAB-DU's resource configuration to the first IAB-donor CU via XnAP message.

Solution 3: A boundary IAB node sends second parent IAB-DU's resource configuration to the first IAB-donor CU via RRC or F1AP message.

In some implementations, the resource configuration comprises at least one of the following: gNB-DU cell resource configuration and/or cell specific signal/channel configuration. The gNB-DU cell resource configuration comprises at least one of the following: subcarrier spacing, DUF Transmission Periodicity, DUF slot configuration list, HSNA transmission periodicity, HSNA slot configuration list. The cell specific signal/channel configuration comprises at least one of the following: IAB STC information, RACH, CSI-RS/SR configuration, PDCCH Configuration SIB1, SCS Common.

Implementation 3—Resource Coordination to Meet Half Duplex Constraint

The following solutions are provided to address inter-donor CU migration or inter-donor CU topology redundancy scenarios.

### Solution

The second IAB donor CU and the second parent IAB node need to be aware of the following boundary IAB-node DU's configuration information in order to avoid interference between child link and parent link.

Step 1: the first IAB-donor CU sends migrating IAB node's/boundary IAB-node's resource configuration information to the second IAB-donor CU.

Step 2: the second IAB-donor CU sends migrating IAB node's/boundary IAB-node's resource configuration information to the second parent IAB node via F1AP message.

In some implementations, resource configuration information comprises at least one of the following: gNB-DU cell resource configuration, cell specific signal/channel configuration and multiplexing information. The gNB-DU cell resource configuration comprises at least one of the following: subcarrier spacing, DUF transmission periodicity, DUF slot configuration list, HSNA transmission periodicity, HSNA slot configuration list. The cell specific signal/channel configuration comprises at least one of the following: IAB STC information, RACH, CSI-RS/SR configuration, PDCCH configuration SIB1, SCS common.

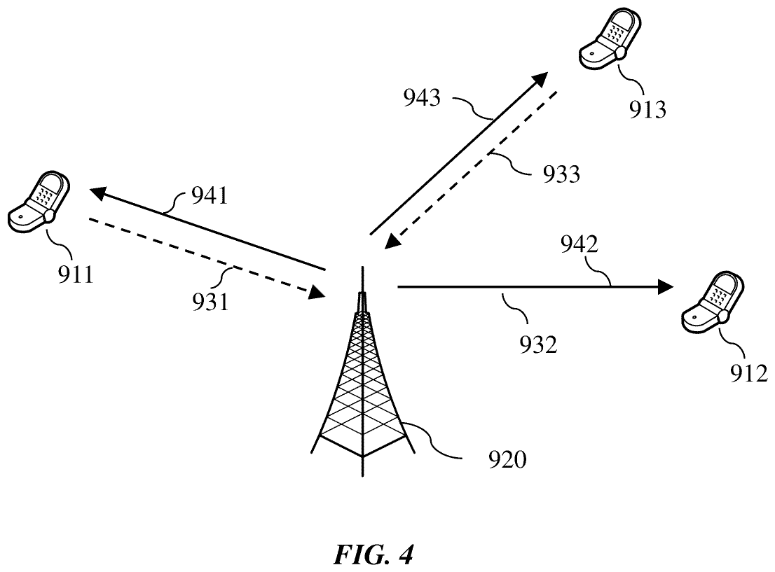

The implementations as discussed above will apply to a wireless communication. FIG. 4 shows an example of a wireless communication system (e.g., a 5G or NR cellular network) that includes a base station 920 and one or more user equipment (UE) 911, 912 and 913. In some embodiments, the UEs access the BS (e.g., the network) using implementations of the disclosed technology 931, 932, 933), which then enables subsequent communication (941, 942, 943) from the BS to the UEs. The UE may be, for example, a smartphone, a tablet, a mobile computer, a machine to machine (M2M) device, an Internet of Things (IoT) device, and so on.

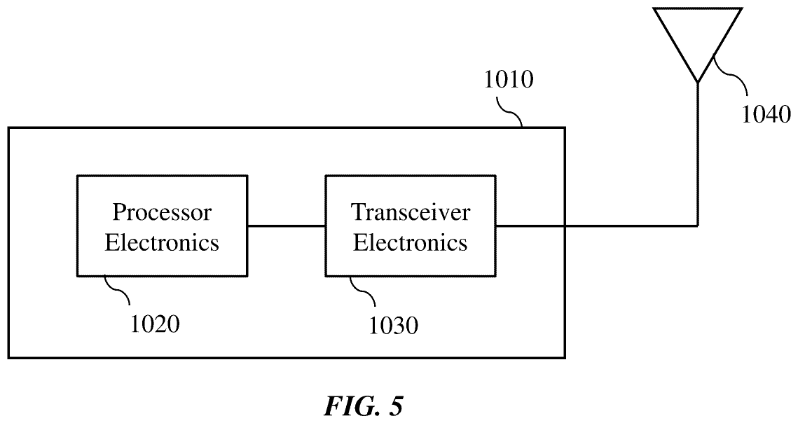

FIG. 5 shows an example of a block diagram representation of a portion of an apparatus. An apparatus 1010 such as a base station or a user device which may be any wireless device (or UE) can include processor electronics 1020 such as a microprocessor that implements one or more of the techniques presented in this document. The apparatus 1010 can include transceiver electronics 1030 to send and/or receive wireless signals over one or more communication interfaces such as antenna 1040. The apparatus 1010 can include other communication interfaces for transmitting and receiving data. The apparatus 1010 can include one or more memories (not explicitly shown) configured to store information such as data and/or instructions. In some implementations, the processor electronics 1020 can include at least a portion of transceiver electronics 1030. In some embodiments, at least some of the disclosed techniques, modules or functions are implemented using the apparatus 1010.

Additional features of the above-described methods/techniques that may be preferably implemented in some implementations are described below using a clause-based description format.

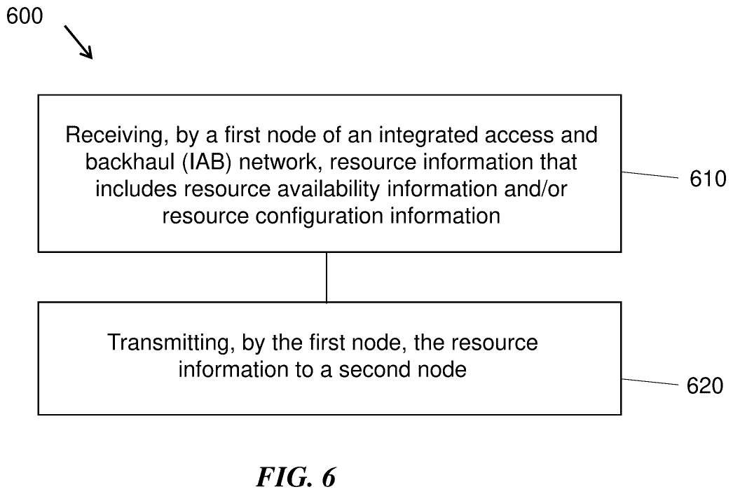

1. A method of wireless communication (e.g., method 600 as shown in FIG. 6A), comprising: receiving 610, by a first node of an integrated access and backhaul (IAB) network, resource information that includes resource availability information and/or resource configuration information; and transmitting 620, by the first node, the resource information to a second node.

2. The method of clause 1, wherein the first node corresponds to a donor node, and the second node corresponds to a first IAB node or a donor node, wherein the first IAB node is a parent node of the second IAB node.

3. The method of clause 1, wherein the resource availability information includes information that is used to indicate a resource availability of soft symbols for a set of slots in a time domain.

4. The method of clause 3, wherein the resource availability information is received from a third node that is a child node of the second node.

5. The method of clause 4, wherein the resource availability information received from the third node is from a fourth node that is another parent node of the third node.

6. The method of clause 3, wherein the resource availability information is received from a fifth node that is a parent node of the second IAB node.

7. The method of clause 1, wherein the resource availability information transmitted to the second node is further transmitted to a first IAB node that is a parent node of a second IAB node.

8. The method of any of clauses 1 to 7, wherein the resource availability information includes at least one of: resource availability indication information, identity of IAB-DU (distributed unit), identity of IAB-DU cell, identity of collocated IAB-MT (mobile termination), subcarrier spacing, DUF (downlink/uplink/flexible) transmission periodicity, DUF slot configuration list, HSNA (hard/soft/not-available) transmission periodicity, HSNA slot configuration list, mutiplex capability information, or cell specific configuration.

9. The method of clause 1, wherein the resource configuration information includes at least one of (i) gNB-DU (distributed unit) cell resource configuration including at least one of subcarrier spacing, DUF (downlink/uplink/flexible) transmission periodicity, DUF slot configuration list, HSNA (hard/soft/not-available) transmission periodicity, or HSNA slot configuration list, or (ii) cell specific configuration.

10. The method of any of clauses 1 to 9, wherein the receiving is performed via an Xn application protocol (XnAP) message or a F1 application protocol (FLAP) message or a radio resource control (RRC) message.

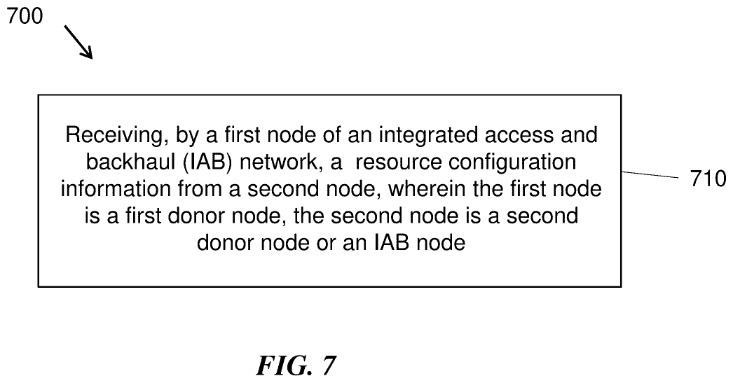

11. A method of wireless communication (e.g., method 700 as shown in FIG. 7), comprising: receiving 710, by a first node of an integrated access and backhaul (IAB) network, a resource configuration information from a second node, wherein the first node is a first donor node, the second node is a second donor node or an IAB node.

12. The method of clause 11, wherein the resource configuration information includes resource configurations of at least one of (i) another IAB node or (ii) a parent node of another IAB node.

13. The method of clause 11 or 12, wherein the resource configuration information includes at least one of (i) gNB-DU (distributed unit) cell resource configuration including at least one of subcarrier spacing, DUF (downlink/uplink/flexible) transmission periodicity, DUF slot configuration list, HSNA (hard/soft/not-available) transmission periodicity, or HSNA slot configuration list, or (ii) cell specific configuration.

14. The method of any of clauses 11 to 13, wherein the receiving is performed via an Xn application protocol (XnAP) message or a F1 application protocol (FLAP) message or a radio resource control (RRC) message.

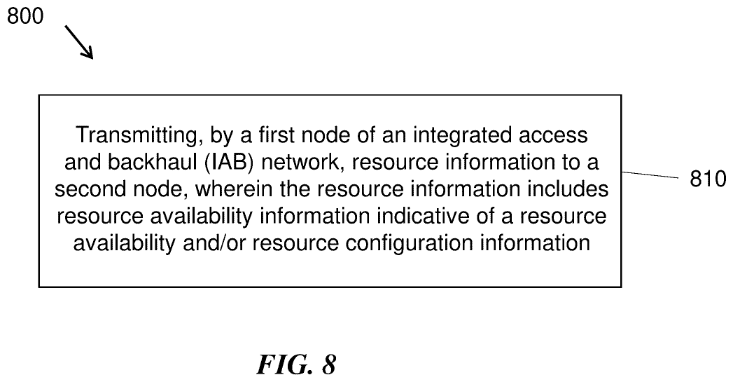

15. A method of wireless communication (e.g., method 800 as shown in FIG. 8), comprising: transmitting 810, by a first node of an integrated access and backhaul (IAB) network, resource information to a second node, wherein the resource information includes resource availability information indicative of a resource availability and/or resource configuration information.

16. The method of clause 15, wherein the first node corresponds to an IAB node and the second node corresponds to a donor node.

17. The method of clause 15, wherein the first node is a migrating IAB node or a boundary IAB node and the second node corresponds to a donor node.

18. The method of clause 15, wherein the first node corresponds to a first IAB donor node and the second node corresponds to a second IAB donor node.

19. The method of any of clauses 15-18, wherein the resource information includes at least one of: resource availability indication information, identity of IAB-DU (distributed unit), identity of IAB-DU cell, identity of collocated IAB-MT (mobile termination), subcarrier spacing, DUF (downlink/uplink/flexible) transmission periodicity, DUF slot configuration list, HSNA (hard/soft/not-available) transmission periodicity, HSNA slot configuration list, mutiplex capability information, or cell specific configuration.

20. The method of any of clauses 15-18, wherein the resource information includes at least one of (i) gNB-DU (distributed unit) cell resource configuration including at least one of subcarrier spacing, DUF (downlink/uplink/flexible) transmission periodicity, DUF slot configuration list, HSNA (hard/soft/not-available) transmission periodicity, or HSNA slot configuration list, or (ii) cell specific configuration.

21. The method of any of clauses 15-18, wherein the transmitting is performed via an Xn application protocol (XnAP) message or a F1 application protocol (FLAP) message or a radio resource control (RRC) message.

22. A communication apparatus comprising a processor configured to implement a method recited in any one or more of clauses 1 to 21.

23. A computer readable medium having code stored thereon, the code, when executed, causing a processor to implement a method recited in any one or more of clauses 1 to 21.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a first node of an integrated access and backhaul (IAB) network, resource information that includes resource availability information and/or resource configuration information; and
transmitting, by the first node, the resource information to a second node, and wherein the resource availability information includes information that is used to indicate a resource availability of soft symbols for a set of slots in a time domain.

2. The method of claim 1, wherein the first node corresponds to a donor node, and the second node corresponds to a first IAB node or a donor node, wherein the first IAB node is a parent node of a second IAB node.

3. The method of claim 1, wherein the resource availability information is received from a third node that is a child node of the second node, wherein the resource availability information received from the third node is from a fourth node that is another parent node of the third node.

4. The method of claim 2, wherein the resource availability information is received from a fifth node that is a parent node of the second IAB node.

5. The method of claim 1, wherein the resource availability information transmitted to the second node is further transmitted to a first IAB node that is a parent node of a second IAB node.

6. The method of claim 1, wherein the resource availability information includes at least one of: resource availability indication information, identity of IAB-DU (distributed unit), identity of IAB-DU cell, identity of collocated IAB-MT (mobile termination), subcarrier spacing, DUF (downlink/uplink/flexible) transmission periodicity, DUF slot configuration list, HSNA (hard/soft/not-available) transmission periodicity, HSNA slot configuration list, multiplex capability information, or cell specific configuration.

7. The method of claim 1, wherein the resource configuration information includes at least one of (i) gNB-DU (distributed unit) cell resource configuration including at least one of subcarrier spacing, DUF (downlink/uplink/flexible) transmission periodicity, DUF slot configuration list, HSNA (hard/soft/not-available) transmission periodicity, or HSNA slot configuration list, or (ii) cell specific configuration.

8. The method of claim 1, wherein the receiving is performed via an Xn application protocol (XnAP) message or a F1 application protocol (F1AP) message or a radio resource control (RRC) message.

9. A method of wireless communication, comprising:
receiving, by a first node of an integrated access and backhaul (IAB) network, a resource configuration information from a second node,
wherein the first node is a first donor node, the second node is a second donor node or an IAB node, and wherein the resource configuration information includes resource configurations of at least one of (i) another IAB node or (ii) a parent node of another IAB node.

10. The method of claim 9, wherein the resource configuration information includes at least one of (i) gNB-DU (distributed unit) cell resource configuration including at least one of subcarrier spacing, DUF (downlink/uplink/flexible) transmission periodicity, DUF slot configuration list, HSNA (hard/soft/not-available) transmission periodicity, or HSNA slot configuration list, or (ii) cell specific configuration.

11. The method of claim 9, wherein the receiving is performed via an Xn application protocol (XnAP) message or a F1 application protocol (F1AP) message or a radio resource control (RRC) message.

12. A method of wireless communication, comprising:
transmitting, by a first node of an integrated access and backhaul (IAB) network, resource information to a second node,
wherein the resource information includes resource availability information indicative of a resource availability and/or resource configuration information.

13. The method of claim 12, wherein the first node corresponds to an IAB node and the second node corresponds to a donor node, wherein the first node is a migrating IAB node or a boundary IAB node and the second node corresponds to a donor node, or, wherein the first node corresponds to a first IAB donor node and the second node corresponds to a second IAB donor node.

14. The method of claim 12, wherein the resource information includes at least one of:
resource availability indication information, identity of IAB-DU (distributed unit), identity of IAB-DU cell, identity of collocated IAB-MT (mobile termination), subcarrier spacing, DUF (downlink/uplink/flexible) transmission periodicity, DUF slot configuration list, HSNA (hard/soft/not-available) transmission periodicity, HSNA slot configuration list, multiplex capability information, or cell specific configuration.

15. The method of claim 12, wherein the resource information includes at least one of (i) gNB-DU (distributed unit) cell resource configuration including at least one of subcarrier spacing, DUF (downlink/uplink/flexible) transmission periodicity, DUF slot configuration list, HSNA (hard/soft/not-available) transmission periodicity, or HSNA slot configuration list, or (ii) cell specific configuration.

16. The method of claim 12, wherein the transmitting is performed via an Xn application protocol (XnAP) message or a F1 application protocol (FLAP) message or a radio resource control (RRC) message.

17. A communication apparatus comprising a processor configured to implement a method comprising:
receiving resource information that includes resource availability information and/or resource configuration information; and
transmitting the resource information to a second node, and
wherein the resource availability information includes information that is used to indicate a resource availability of soft symbols for a set of slots in a time domain.

18. The communication apparatus of claim 17, wherein the resource availability information is received from a third node that is a child node of the second node, and wherein the resource availability information received from the third node is from a fourth node that is another parent node of the third node.

19. The communication apparatus of claim 17, wherein the resource availability information transmitted to the second node is further transmitted to a first IAB node that is a parent node of a second IAB node.

20. The communication apparatus of claim 17, wherein the resource availability information includes at least one of: i) resource availability indication information, ii) identity of IAB-DU (distributed unit), iii) identity of IAB-DU cell, identity of collocated IAB-MT (mobile termination), iv) subcarrier spacing, v) DUF (downlink/uplink/flexible) transmission periodicity, DUF slot configuration list, vi) HSNA (hard/soft/not-available) transmission periodicity, vii) HSNA slot configuration list, viii) multiplex capability information, ix) cell specific configuration, x) gNB-DU (distributed unit) cell resource configuration including at least one of subcarrier spacing, DUF (downlink/uplink/flexible) transmission periodicity, DUF slot configuration list, HSNA (hard/soft/not-available) transmission periodicity, or HSNA slot configuration list, or xi) cell specific configuration.
